(19) United States
(12) Patent Application Publication
(10) Pub. No.: US 2018/0313606 A1
(43) Pub. Date: Nov. 1, 2018

(54) Passive Ventilation Herb Psychrometer

(71) Applicant: John Patrick Perna, Sterling, AK (US)

(72) Inventor: John Patrick Perna, Sterling, AK (US)

(73) Assignee: John Patrick Perna, Sterling, AK (US)

(21) Appl. No.: 15/497,523

(22) Filed: Apr. 26, 2017

(51) Int. Cl. F26B 9/06; F26B 25/16; F26B 21/00

(52) U.S. Cl. CPC F26B 9/06; F26B 3/04; F26B 21/004; F26B 25/16

(57) ABSTRACT

This device is used for the drying of vegetative matter for human ingestion. This device is designed to create a closed environment in which the user can fine tune the operation depending on what is being dried, and also provide the ability to manage any odors generated by the process. The user harvests the herbs in question and hangs them inside the drying chamber. The device is called a ‘Passive Ventilation Psychrometer’ because it contains no air moving mechanism. The user has to install and establish an exhaust system for evacuating the air within the device. The user is also responsible for setting up the intake air, which gives said user some control over the temperature and humidity of the incoming air. The user also sets up the hydration chamber to control humidity up or down, depending on ambient conditions.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

This device is for drying various types of vegetative matter, which either require, or will benefit from a controlled environment during the drying process.

### Description of Related Art Including Information Disclosed Under 37 CFR 1.97

### Prior Art

Various types of commercially available herb drying devices are available. Some types use a solid metal box in which material is hung and dried with fans and/or sensors to monitor and control internal environment. Others are re-purposed metal filing cabinets with hanging racks and maybe a fan inside. Simple hanging devices or dry net hangers which simply hang inside or outside and let material air dry, have been around for a long time.

Drying herbs helps protect them from bacteria, mold and yeast. Most herbs benefit from drying in a controlled environment with regard to temperature, humidity and light. This device is designed to provide an environment which will give the user options for controlling those elements.

Indoor drying of vegetative matter is often the preferred method as it will keep the color, flavor and other qualities intact when compared to outdoor or sun drying. Indoor drying also makes it easier to recreate conditions time after time for a consistent product, and helps oil preservation.

This device can be used for drying Chamomile, Thyme, Rosemary, Sage, Basil, Parsley, Mint, Tarragon, Tobacco, Cannabis, Wildflowers and many others. Some herbs like Thyme, Rosemary, Sage, Tobacco and Cannabis benefit from slow drying, while others like Basil, Parsley and Mint benefit from drying quickly.

### BRIEF SUMMARY OF THE INVENTION

The Passive Ventilation Herb Psychrometer is a device used to dry flowers and other herbs, within a closed system, and provides the user options with regard to controlling temperature, air flow rate & humidity. Fabricated mostly of ¾″, ½″ and ¼″ Plywood, the device is designed to dry vegetative matter slowly, and provide a way to manage any odors generated during the drying process.

### BRIEF DESCRIPTION OF THE SEVERAL VIEWS OF THE DRAWING(S)

FIG. 1 is a perspective from front/right view of a Psychrometer with RH door (11) swing & right side air intake (10) and right side cable pass through (25). The screen (26) which separates the drying chamber (upper section) from the hydration chamber (lower section), has been removed, but the aluminum rails (12) on which it sits are visible.

FIG. 2 is an elevation of the front view, with the door closed. The exhaust port (13) is visible in this view.

FIG. 3 is an elevation of the right side. Note: the air intake (10), and the cable pass through (25), are available installed on the sides or rear of the device.

FIG. 4 is the top view. Dimensions shown in this view are meant to point out that the base (14) footprint is smaller than the upper chamber of the device. Even more so when accounting for air intake (10), hinges (20) and hatch clasp's (21), which all protrude out from the device slightly.

FIG. 5 is a view from below looking at the bottom. Here we can start to see the internal workings of the device. The air intake raceway (16) terminates at the approximate center of the base (18). The number 18, used several times in the drawings, does not refer to an object, but rather a location. The center of the base (18). Unrestricted air flows in here, and can be more evenly distributed upwards through the device. (#24) indicates a phantom line representing where the inner chamber walls sit in relation to the Base Vertical Vent holes (15).

FIG. 6 is a perspective of the Base (14), which is built first, as an individual, customizable, component. This drawing is intended to enable visualization of the air intake mechanism employed by this device. A section of the Base (14) top, has been cut away to visualize the internal structure. Important to note is that the height of the air intake raceway (16) is less than the inner height of the base, as air needs to move over the raceway to get up through the Base Vertical Vent Hole's (15). To reduce weight, a piece of flexible 4″ ducting can be fitted in place of the raceway, engineered to terminate at the Base center (18).

FIG. 7 is an elevation of the front of the device, with the door removed, and is intended to show the air flow dynamics of the device. This is the heart of this device, as it is this method of air exchange (named ‘Overflow’) which enables slow drying. This drawing assumes the device is being ventilated. Follow the black arrows from the Air Flow Intake (10) as the incoming air travels through the raceway (16) and enters the Base (14) at base center, (18). Air is being pulled up through the device, so after entering the Base (14) the air is pulled up through the Base Vertical Vent Holes (15), and travels upward past honeycombed chamber walls (23). Airflow terminates over the top of the drying chamber and out through the exhaust port (13). The removable screen (26) which separates the upper and lower chambers is shown in this view.

FIG. 8 is the removable screen (26) which separates the upper and lower chambers, but still allows air to move between the two. The screen is standard residential window screen stretched over a wooden frame.

FIG. 9 is the same perspective as FIG. 1 with some additions to provide another view of the internal working of the device. Here we can clearly see how the inner chamber sits within the outer shell, and how the air flow is restricted to the cavity between the outer shell and the inner chamber. We can better see that air in the Base (14) is confined to travel only up through the Base Vertical Vent Holes (15). Not pictured are the stand-off devices that provide stability to the inner chamber. They are wooden dowels glued to the inner chamber and exterior walls, joining the inner & outer chambers as one. The exhaust port (13) is shown in this drawing, but the Cable Pass Through (25) is not shown to aid visualization of the interior. Overall dimensions are also shown in this drawing.

FIG. 10 please use on the cover of this patent application publication.

### DETAILED DESCRIPTION OF THE INVENTION

Designed specifically to pro-actively address the problems associated with the drying and subsequent curing of different types of herbs for human ingestion. The device has two moving parts, the door & air intake flapper valve, as well as a removable screen (26) designed to separate the drying chamber (top section) from the hydration chamber (lower section). The main problems associated with herb drying are odor management and temperature and humidity control. First are the odors associated with drying vegetative matter, which can be formidable, especially in a residential setting. This device has a 4″ air intake (10) built into the base, and a 4″ exhaust vent (13) ported out the top of the device. Users must provide a ventilation source such as an in-line exhaust fan with timer control, and connect to the exhaust port (13). When in use, this air suction will cause air to be drawn in through the base (14), then travel up through the device. The air intake (10) in the base, has a flapper valve which closes during non-ventilation times, preventing odor from migrating back through the intake port. This process of preventing odor migration back through the intake port can be augmented by attaching a length of flexible ducting to said port, which can also serve the purpose of controlling the source of your intake air, simply depending on where it is placed. There is also a Cable Pass Through (25) which is double sided and is designed to allow electrical cord use without odor migration. The base (14) is designed with a raceway (16) which allows air to be introduced, without constriction, into the center of the base cavity (18), allowing equal air distribution upwards through the device. Secondly is controlling the environment with regard to temperature and humidity. Most vegetative matter has very specific requirements for the drying process, usually unique to the species, which will result in a quality product. This device allows the user control over incoming air, depending on placement of air intake portal, and by definition, the temperature of the incoming air. The lower half of the inner chamber is for humidity control, providing the user the option to either increase or decrease the humidity within the device. The interior design of the drying chamber allows for air exchange, without moving air passing directly over the material being dried, thereby slowing the drying process. The speed at which herbs dry often has a great impact on quality, and this drying method of controlled humidity, combined with slow air exchange, allows for fine tuning of the drying process. The device has also been successfully tested by connecting the exhaust to a mechanically ventilated room, the negative pressure of which provided the only ventilation for the device, drawing air at less than 3 cfm.

Optional configurations include exteriors & interiors made of exotic woods, decorative exteriors, custom locations for air intake & 4 sided interior ventilation. The deluxe version would be entirely made of exotic wood, with 4-sided interior ventilation, decorative exterior & multi-zone hygrometers and temperature sensors built into the door.

This device is manufactured using traditional woodworking techniques, and uses plywood's conforming to ANSI 117. The design concept for the device started with a desire to keep weight down, which is why the device has no real internal supporting frame. Another important factor was the wood interior, which over time should absorb odors and become, ‘seasoned’ for lack of a better term. This can be beneficial when the unit is repeatedly used to dry the same type of vegetative matter.

The base is made of ¾″ plywood as it is flatter than structural lumber and deters insects. It is glued and fastened with brads and extra re-enforcement in the corners. The base top is also ¾″ plywood, glued and nailed to base walls. Air Intake Raceway, made of ½″ plywood or a flexible ducting material, is made independently and installed into base. A commercially purchased flapper valve with ducting extrusion is installed.

The upper chamber outer walls are fabricated from plywood, one side sanded, with traditional woodworking techniques. All components are fabricated from detailed computer renderings, and assembled post fabrication. The interior drying chamber honeycombed walls are fabricated from a thin ¼″ plywood, but are ideally fabricated from fruit tree woods.

Unique elements of this device are as follows:

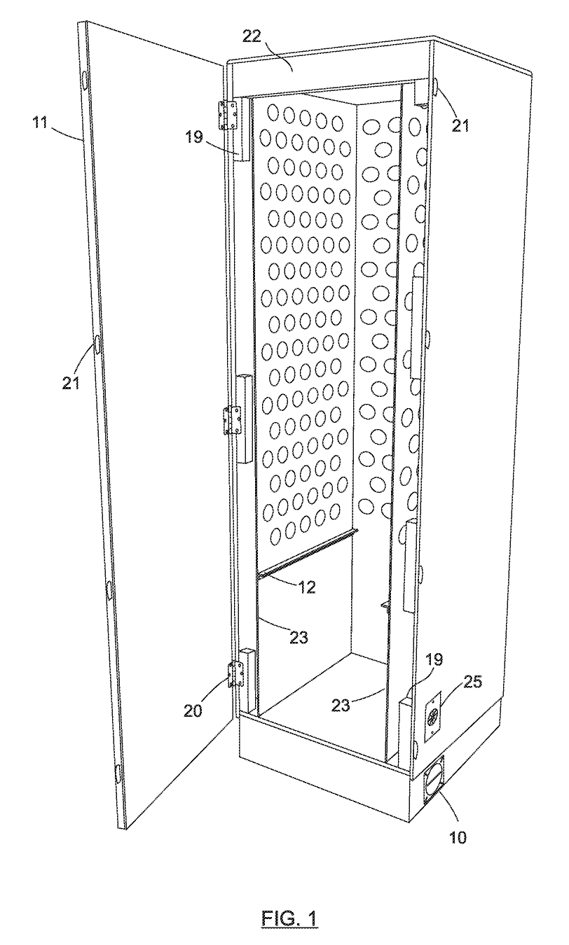

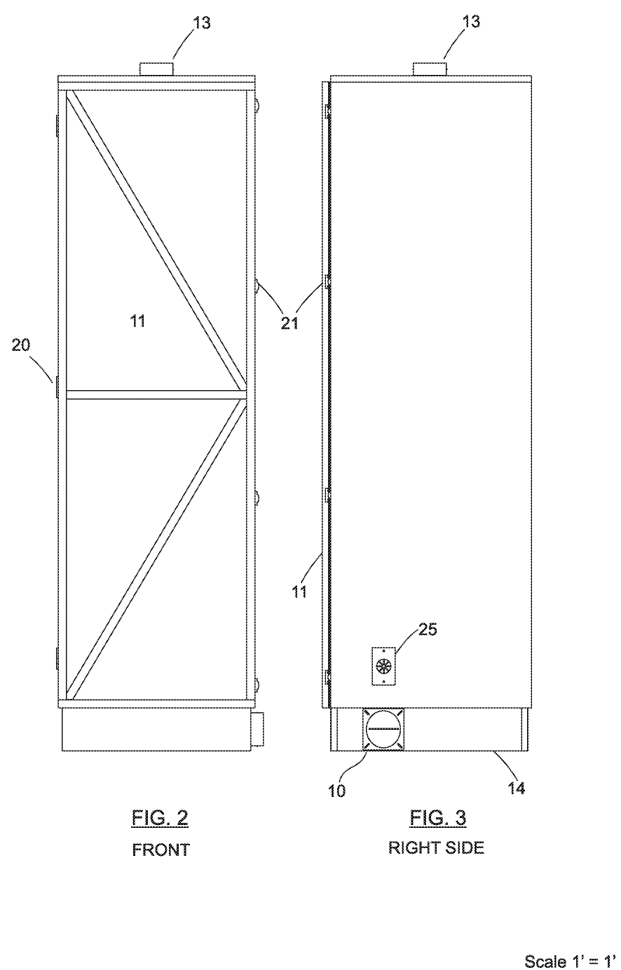

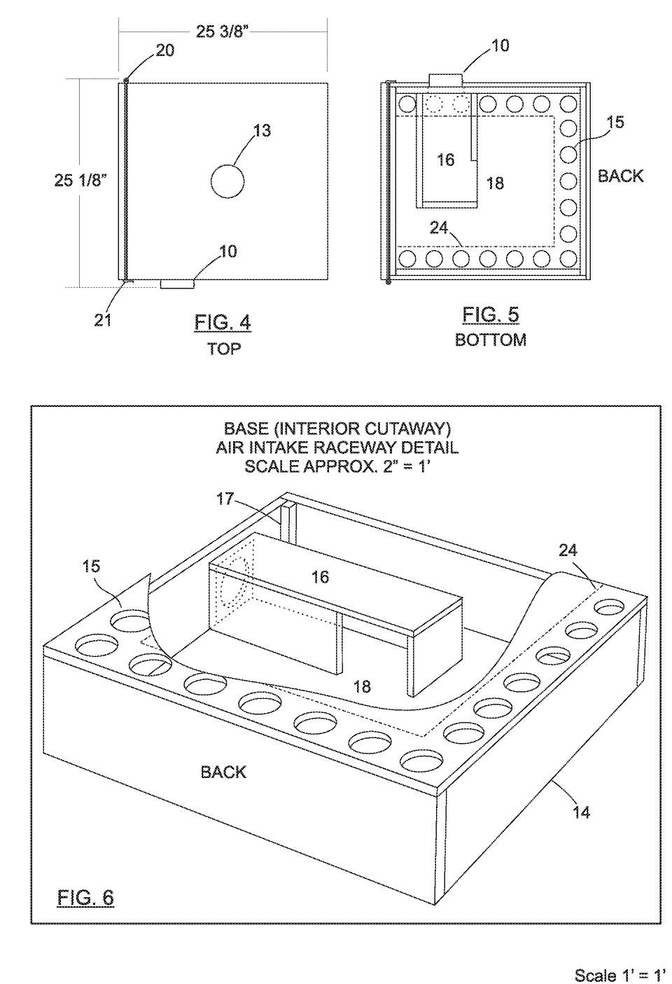

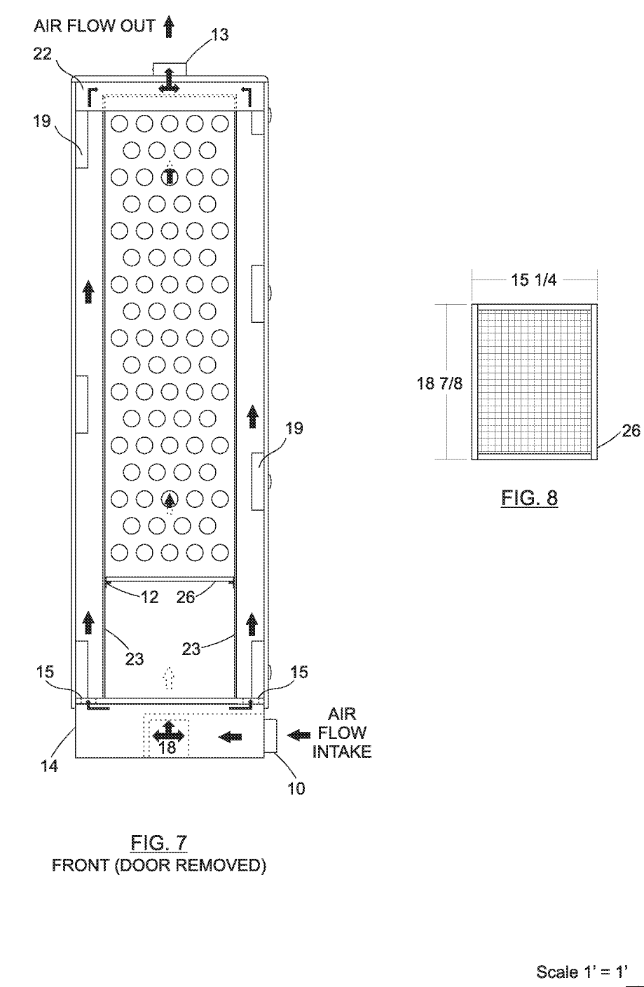

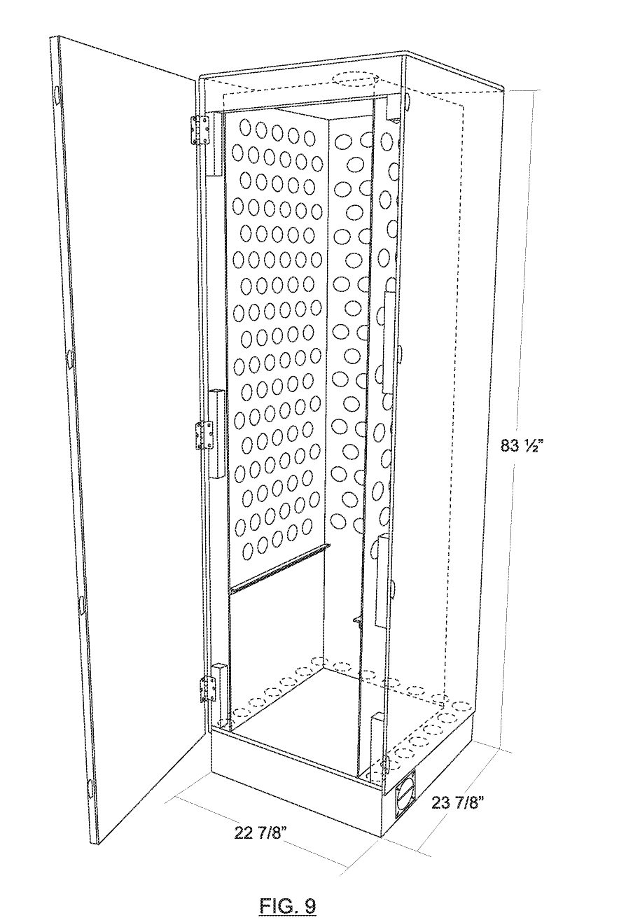

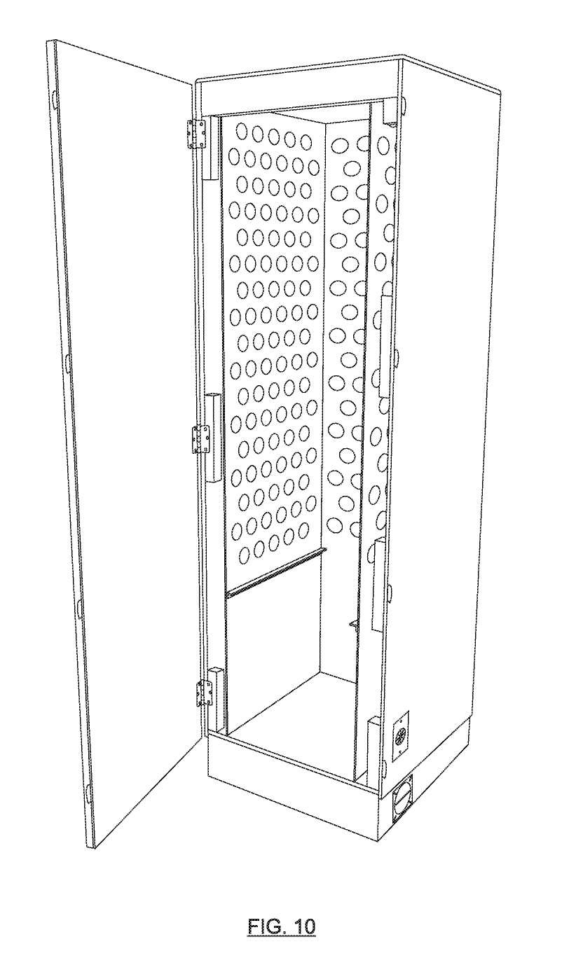

10-Base intake raceway. See FIG. 6 Raceway Detail. The raceway's function is the unrestricted airflow through the base, allowing for equal distribution of incoming air up through all 3, or 4 sides of the interior, depending on the model. Without the raceway, most of the incoming air would follow the path of least resistance and migrate up the side of the cabinet closest to the intake, thereby creating unequal distribution of incoming air.
12—Interior drying chamber. See FIG. 1 & FIG. 8. The honeycomb style interior walls separate the drying chamber, (where material being dried actually hangs), from the air movement chambers directly on the other side. The proportionality between the hole size & quantity is a crucial element to the functionality of this device. Equally important to note is that the hydration chamber (lower section) walls are solid.
14—‘Overflow’ Air Drying System. The internal structure with regard to the exact way in which air is brought in, distributed and evacuated from the device has been termed ‘Overflow’ air drying system, and is a unique creation. The term refers to the way air ‘flows over’ the cavity it is meant to evacuate. A simple way to think about this device is a box within a box, with airflow confined to the cavity between the two.
16—The Hydration Chamber is a space dedicated to humidity control. This can be achieved through either passive methods or electronic devices. Passively increasing humidity can be achieved through simple evaporation techniques or use of electronic humidity controlling devices. Decreasing humidity can likewise be achieved through passive or electronic means. The user is responsible to fine tune their device to accommodate the local environmental conditions and the species in question.

What is claimed is:

1. An herb drying cabinet made mostly of wood, which is designed to evenly distribute airflow without air passing directly over material being dried, thereby slowing the drying process.

2. An herb drying cabinet which gives user control over the internal environment of the device with regard to temperature, humidity and air flow rate.

3. An herb drying cabinet which is distinguished by the internal structure which allows for air exchange to occur at a rate established by the user, with no airflow directly over the vegetative matter and even distribution of the incoming air.

4. The internal structure with regard to the exact way in which air is brought in, distributed and evacuated from the device has been termed ‘Overflow’ air drying system.
